(19) United States
(12) Patent Application Publication
(10) Pub. No.: US 2011/0046916 A1
(43) Pub. Date: Feb. 24, 2011

(54) Pyrometer

(75) Inventors: Ming Lun Yu, Fremont, CA (US); Markus E. Beck, Scotts Valley, CA (US)

Correspondence Address: STEPTOE & JOHNSON LLP, 1330 CONNECTICUT AVENUE, N.W., WASHINGTON, DC, 20036, US

(73) Assignee: First Solar, Inc., Perrysburg, OH (US)

(21) Appl. No.: 12/860,125

(22) Filed: Aug. 20, 2010

Related U.S. Application Data
(60) Provisional application No. 61/235,855, filed on Aug. 21, 2009.

(51) Int. Cl. G01J 5/02; G01J 5/00; G06F 15/00

(52) U.S. Cl. 702/150; 374/121; 250/339.07; 250/341.8; 250/338.3

(57) ABSTRACT

A position sensitive pyrometer includes a sensor.

### CLAIM OF PRIORITY

This application claims priority to U.S. Provisional Patent Application No. 61/235,855, filed on Aug. 21, 2009, which is incorporated by reference in its entirety.

### TECHNICAL FIELD

This invention relates to a position sensitive pyrometer with an in-situ configuration for in-line deposition process.

### BACKGROUND

Thermal radiation is electromagnetic radiation emitted from the surface of an object which is due to the object's temperature. Non-contacting thermometers or pyrometers can detect and measure the thermal radiation to determine the object's temperature. Therefore, pyrometers can represent a suitable solution for the measurement of moving objects or any surfaces in conditions in which contacting or otherwise touching the object can be difficult or not possible.

### DESCRIPTION OF DRAWINGS

FIG. 1 illustrates a configuration of a position sensitive pyrometer with an in-situ configuration for in-line deposition process.

FIG. 2 is a perspective view illustrating that the thermal radiation from different locations of the substrate's surface are directed through plurality of optic lens and fiber cable.

FIG. 3 is a top view illustrating the thermal radiation from different locations of the substrate's surface are directed through plurality of optic lens and fiber cable and detected by a 2D pixel array sensor.

FIG. 4 is a close-in view of a 2D pixel array sensor and a slit mask.

FIG. 5 is a perspective view illustrating that a typical optic setting of measuring thermal radiation.

FIG. 6 illustrates a configuration of a position sensitive pyrometer with a separate light source.

### DETAILED DESCRIPTION

Pyrometers detect and measure the thermal radiation to determine the object's temperature. To measure the position sensitive temperature, a spatially dependent pyrometer is developed with an in-situ configuration for in-line deposition process. By directing the thermal radiation from different locations of the substrate's surface, position sensitive temperature information can be obtained. A 2D pixel array sensor is used to measure the thermal radiation. The position sensitive pyrometer can also include an active spectral pyrometry device to extract deposited film thickness information by measuring and analyzing both the self-emission and reflection of a surface of the deposited film on the substrate.

Thermal radiation is generated when heat from the movement of charged particles within atoms is converted to electromagnetic radiation. Pyrometer has an optical system and detector. The optical system focuses the thermal radiation onto the detector. The output signal of the detector is related to the thermal radiation of the target object through the Stefan-Boltzmann law.

### Let

J*=thermal radiation or irradiance

ε=emissivity of the object

σ=constant of proportionality.

Stefan-Boltzmann law states that

J*=εσT⁴

This output is used to infer the object's temperature. Therefore, there is no need for direct contact between the pyrometer and the object.

In one aspect, a method of monitoring a substrate can include directing thermal radiation from a substrate to a pixel array sensor, wherein the substrate has a surface and measuring temperature of the substrate from the thermal radiation by the pixel array sensor. The surface can include a film deposited on the substrate. The step of directing thermal radiation from a substrate to a pixel array sensor can include directing thermal radiation from different positions of the substrate to different segments of the pixel array sensor, respectively.

In certain circumstances, the method can further include the step of measuring temperature and correlating the temperature to the substrate at different positions. The method can further include the step of directing thermal radiation from a source to the film deposited on the substrate. The method can further include the steps of obtaining spectra of emission and reflection energy from the film and extracting deposited film thickness information based on the spectra of emission and reflection energy. The pixel array sensor can include an infrared detector. The array sensor can include an infrared detector having a wavelength measurement range about 500 to about 1000 nm. The pixel array sensor can include an infrared detector having a wavelength measurement range about 1000 nm to about 100 micron. The pixel array sensor can include a photoconductive detector. The pixel array sensor can include a photovoltaic detector. The pixel array sensor can include a photodiode detector.

In certain embodiments, the method can further include storing measurement data for analysis. The method can further include processing measurement data in real time. The thermal radiation can be transmitted through optic fiber. The method can further include directing thermal radiation from different positions of the substrate through a slit mask to illuminate a row of segments of the pixel array sensor, wherein the position and temperature information can be correlated. The method can further include dispersing light of different wavelengths in the direction perpendicular to the length of the slit by a wavelength dispersive element, wherein one dimension of the pixel array sensor can contain the position information while the other dimension of the pixel array sensor can contain the wavelength information to obtain position sensitive spectrum information.

In another aspect, a position sensitive pyrometer can include a pixel array sensor and a lens optically connected to the pixel array sensor and proximate to a substrate path, wherein, when a substrate having a surface is in the substrate path, thermal radiation radiates from the substrate through the lens to the pixel array sensor. The surface can include a film deposited on the substrate.

In certain circumstances, the position sensitive pyrometer can further include a plurality of lenses optically connected to the pixel array sensor and proximate to a substrate path, wherein the lenses are directed toward a plurality of positions on the substrate path. When a substrate is in the substrate path, thermal radiation can radiate from a plurality of positions on the substrate through the plurality of lenses to the pixel array sensor. The lens can be optically connected to the pixel array sensor with an optic fiber cable. The position sensitive pyrometer can further include an active spectral pyrometry device configured to extract deposited film thickness information based on spectra of emission and reflection energy from the film. The active spectral pyrometry device can include a light source generating and directing a light beam onto the film. The pixel array sensor can include an infrared detector. The pixel array sensor can include an infrared detector having a wavelength measurement range about 500 to about 1000 nm. The pixel array sensor can include an infrared detector having a wavelength measurement range about 1000 nm to about 100 micron. The pixel array sensor can include a photoconductive detector. The pixel array sensor can include a photovoltaic detector. The pixel array sensor can include a photodiode detector. The position sensitive pyrometer can further include a measurement data storage module for analysis. The position sensitive pyrometer can further include a measurement data processing module for real time diagnosis. The position sensitive pyrometer can further include a slit mask, wherein the thermal radiation from different positions of the substrate is directed through the slit mask to illuminate a row of segments of the pixel array sensor, wherein the position and temperature information can be correlated. The position sensitive pyrometer can further include a wavelength dispersive element to disperse light of different wavelengths in the direction perpendicular to the length of the slit, wherein one dimension of the pixel array sensor can contain the position information while the other dimension of the pixel array sensor can contain the wavelength information to obtain position sensitive spectrum information. The position sensitive pyrometer can further include a spectral imaging module with spectropyrometry.

In another aspect, a position sensitive real time deposition monitor with an in-situ configuration for in line deposition process can include a pixel array sensor including an infrared detector, a lens optically connected to the pixel array sensor and proximate to a substrate path, wherein, when a substrate having a surface is in the substrate path, thermal radiation radiates from a film deposited on the surface through the lens to the pixel array sensor, an active spectral pyrometry device to extract a deposited film thickness information by measuring and analyzing the self-emission of a surface of the deposited film on the substrate, and a measurement data processing module for real time diagnosis.

In certain circumstances, the position sensitive real time deposition monitor can further include a plurality of lenses optically connected to the pixel array sensor and proximate to a substrate path, wherein the lenses are directed toward a plurality of positions on the substrate path. When a substrate is in the substrate path, thermal radiation can radiate from a plurality of positions on the film through the plurality of lenses to the pixel array sensor. The lens can be optically connected to the pixel array sensor with an optic fiber cable. The pixel array sensor can include an infrared detector having a wavelength measurement range about 500 to about 1000 nm. The pixel array sensor can include an infrared detector having a wavelength measurement range about 1000 nm to about 100 micron. The pixel array sensor can include a photoconductive detector. The pixel array sensor can include a photovoltaic detector. The pixel array sensor can include a photodiode detector. The position sensitive real time deposition monitor can further include a measurement data storage module for later analysis. The position sensitive real time deposition monitor can further include a slit mask, wherein the thermal radiation from different positions of the substrate is directed through the slit mask to illuminate a row of segments of the pixel array sensor, wherein the position and temperature information can be correlated. The position sensitive real time deposition monitor can further include a wavelength dispersive element to disperse light of different wavelengths in the direction perpendicular to the length of the slit, wherein one dimension of the pixel array sensor can contain the position information while the other dimension of the pixel array sensor can contain the wavelength information to obtain position sensitive spectrum information. The position sensitive real time deposition monitor can further include a spectral imaging module with spectropyrometry. The position sensitive real time deposition monitor can further include a substrate counting module, wherein the counting module can use the signal change caused by the moving substrates to count the number. With a preset substrate dimension, the counting module can use the signal change caused by the moving substrates to measure the gaps between the substrates and the substrate moving speed.

In another aspect, a method of monitoring a substrate can include directing light from a light source to a substrate, wherein the light source may include a near infrared light source, directing reflection from the substrate to a pixel array sensor, wherein the substrate has a surface, and measuring temperature of the substrate from the reflection by the pixel array sensor. The surface can include a film deposited on the substrate. The step of directing reflection from a substrate to a pixel array sensor can include directing reflection from different positions of the substrate to different segments of the pixel array sensor respectively.

In certain circumstances, the method can further include the step of measuring temperature and correlating the temperature to the substrate at different positions. The method can further include the steps of obtaining spectra of emission and reflection energy from the film and extracting deposited film thickness information based on the spectra of emission and reflection energy. The pixel array sensor can include an infrared detector. The array sensor can include an infrared detector having a wavelength measurement range about 500 to about 1000 nm. The pixel array sensor can include an infrared detector having a wavelength measurement range about 1000 nm to about 100 micron. The pixel array sensor can include a photoconductive detector. The pixel array sensor can include a photovoltaic detector. The pixel array sensor can include a photodiode detector. The method can further include storing measurement data for analysis. The method can further include processing measurement data in real time. The light from the light source and the reflection from the substrate can be transmitted through optic fiber. The method can further include directing reflection from different positions of the substrate through a slit mask to illuminate a row of segments of the pixel array sensor, wherein the position and temperature information can be correlated. The method can further include dispersing light of different wavelengths in the direction perpendicular to the length of the slit by a wavelength dispersive element, wherein one dimension of the pixel array sensor can contain the position information while the other dimension of the pixel array sensor can contain the wavelength information to obtain position sensitive spectrum information.

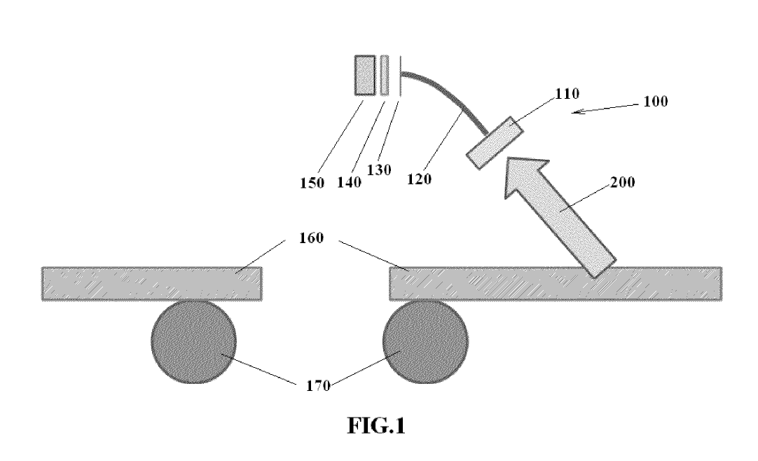

Referring to FIG. 1, position sensitive pyrometer 100 can have lens 110 positioned to receive thermal radiation 200 from moving substrates 160. Optic fiber bundle 120 can be used to transmit thermal radiation 200. Mask 130 and filter 140 can be positioned in front of 2D pixel array sensor 150. 2D pixel array sensor 150 can be used to measure thermal radiation 200.

The position sensitive pyrometer can also include an active spectral pyrometry device to extract deposited film thickness information by measuring and analyzing both the self-emission and reflection energy of a surface of the deposited film on the substrate. With a surface model of the interference of radiation, spectra of emission and reflection energy can be measured and analyzed to estimate the average thickness. In addition, the film thickness information can be used to derive a spatially varying correction to the temperature measurement. The accuracy of the spatially resolved pyrometry temperature measurement is thus improved. The measurement can be done in the frequency range of a near infrared band or through infrared region. The measurement can be done at a given time interval. In certain circumstances, the preset time interval can be less than 1 s, equal to 1 s or greater than 1 s.

Therefore, the invention is capable to real time monitor the temperature and thickness, of different position of a surface whose surface condition or state is changing. In a possible embodiment, the invention can be used to monitor a substrate surface in a high-temperature air-oxidation process, chemical vapor deposition (CVD) process. The invention can also be used to monitor a substrate surface in a physical vapor deposition (PVD) process, such as sputtering or evaporation (thermal or e-beam), or any suitable vapor transport deposition (VTD) process. In a possible embodiment, the invention can be used to monitor a substrate surface in reactive ion etch (RIE) process or any suitable dry etch process.

In certain embodiments, the pyrometer can also be positioned under the substrate path, wherein the pyrometer measure the radiation from the backside of the substrates and only the temperature information can be obtained.

In certain embodiments, the pyrometer can further include a substrate counting module, wherein the counting module can use the signal change caused by the moving substrates on the substrate path to count the number. With a preset substrate dimension, the counting module can further use the signal change caused by the moving substrates to measure the gaps between the substrates and the substrate moving speed.

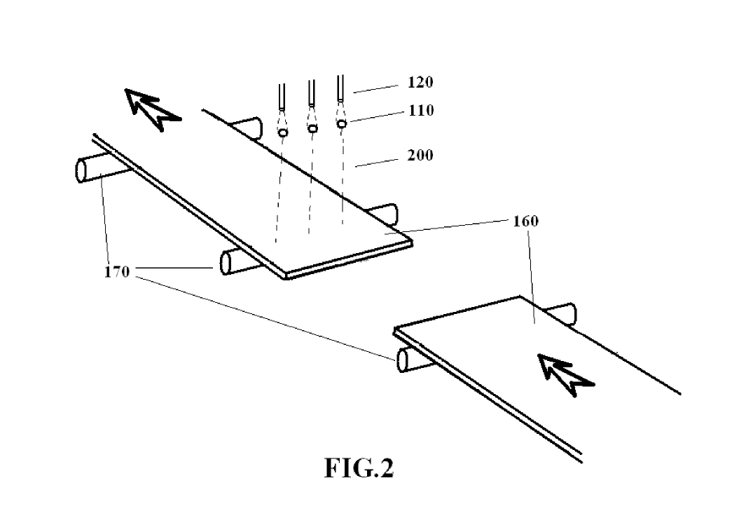

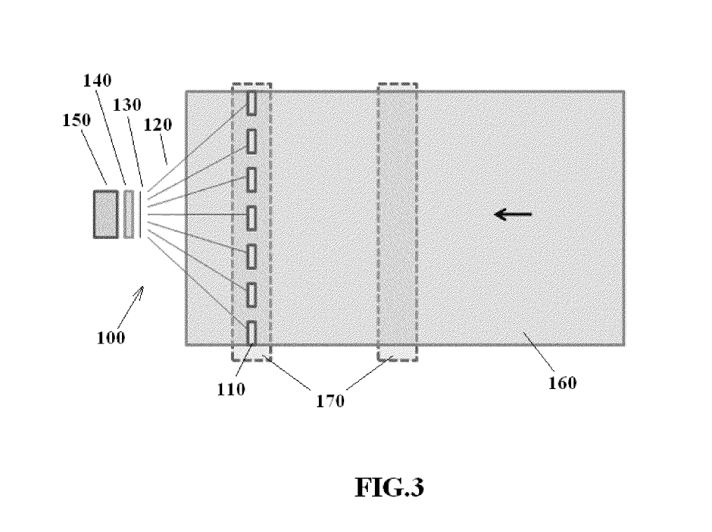

Referring to FIGS. 2 and 3, thermal radiation 200 at different positions can be transmitted by plurality of optic lens 110 and fiber optic cables 120. Therefore, position sensitive temperature information can be obtained. Moving substrates 160 can be used as a shutter of thermal radiation 110 to sense the presence of a substrate and the time stamped information allows the measurement of the translation speed of the substrates on rollers 170 as well as substrate counting. Each split portion of thermal radiation 200 is transmitted by plurality of optic fiber cables 120 and illuminates a given segment of 2D pixel array sensor 150. By measuring the thermal radiation by 2D pixel array sensor 150 (FIG. 1), position-sensitive temperature can be extracted by correlating the measurement results to substrate at different positions.

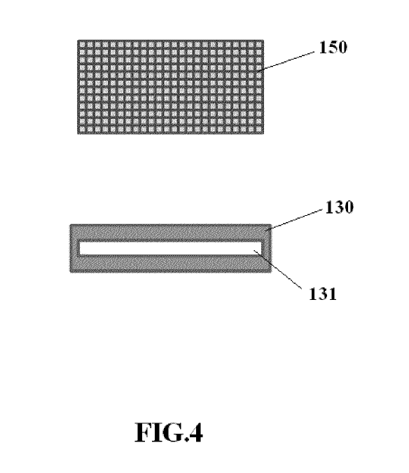

Referring to FIG. 4, mask 130 can include a slit 131. Mask 130 can be positioned in front of 2D pixel array sensor 150. Slit 131 can be used to image each fiber onto a row of pixels. In some embodiments, in between mask 130 and array sensor 150, a wavelength dispersive element such as a grating or a grating/lens combination can be inserted to disperse light of different wavelengths in the direction perpendicular to the length of the slit. The width of the slit, the dispersion property of the grating, and the periodicity of the array in that direction should be matched to give the required wavelength resolution. By doing this, one dimension can contain the position information while the other contains the wavelength information to generate a spectrum for each point. In some embodiments, slit 131 can be a narrow slit to diffract the light so a 1D array can be used where the position of the pixels are exposed to monochromatic portions of the radiation including the initial incoming beam. The size of the narrow slit (width) can be matched to the periodicity of the 1D array to obtain the resulting wavelength resolution. Thus, the 2D array sensor can use the first dimension to detect the position information (localization) of the signal and the second dimension to detect the spectral information either for film thickness or spectropyrometry.

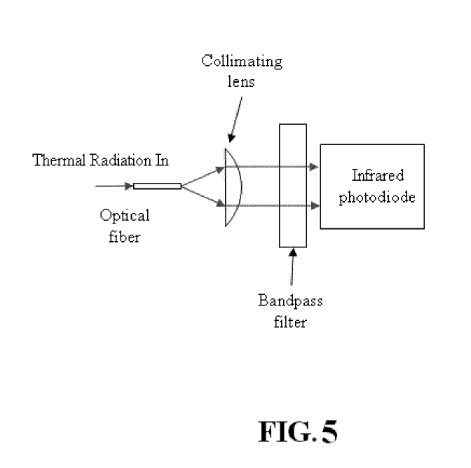

Referring to FIG. 5, a bandpass filter can be positioned in front of the detector. The detector can be an infrared photodiode. The thermal radiation coming out from different positions of substrate 160 (FIG. 1) will be transported by optical fiber vacuum feedthrough. The output will be collimated by a small collimating lens onto an infrared photodiode.

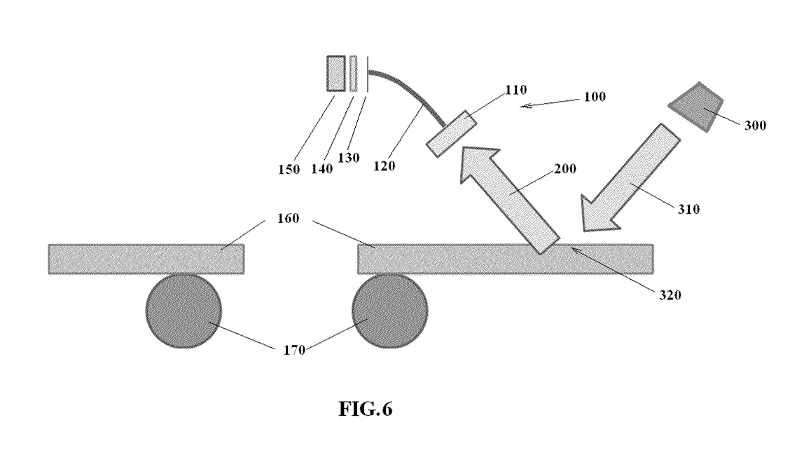

Referring to FIG. 6, position sensitive pyrometer 100 can have a light-in-light-out (LILO) configuration including light source 300. Light 310 can be directed to illuminate measurement area 320 of substrate 160. Light source 300 can be a near infrared light source. Reflection 200 from measurement area 320 of substrate 160 can be directed to pixel array sensor 150. Temperature of the substrate can be measured from reflection 200 by pixel array sensor 150. Substrate 160 can include a deposited film on its surface. Near infrared (NIR) reflectometry can be used to extract deposited film thickness information based on the spectra of emission and reflection energy. In some embodiments, light 310 from light source 300 and reflection 200 from substrate 160 are transmitted through optic fiber.

In some embodiments, position sensitive pyrometer 100 can further direct reflection 200 from different positions of measurement area 320 of substrate 160 through a slit mask to illuminate a row of segments of pixel array sensor 150, wherein the position and temperature information can be correlated. Position sensitive pyrometer 100 can disperse light of different wavelengths in the direction perpendicular to the length of the slit by a wavelength dispersive element, wherein one dimension of the pixel array sensor can contain the position information while the other dimension of the pixel array sensor can contain the wavelength information to obtain position sensitive spectrum information.

A number of embodiments of the invention have been described. Nevertheless, it will be understood that various modifications may be made without departing from the spirit and scope of the invention. It should also be understood that the appended drawings are not necessarily to scale, presenting a somewhat simplified representation of various preferred features illustrative of the basic principles of the invention.

What is claimed is:

1. A method of monitoring a substrate comprising:
directing thermal radiation from a substrate to a pixel array sensor, wherein the substrate has a surface; and
measuring temperature of the substrate from the thermal radiation by the pixel array sensor.

2. The method of claim 1, wherein the surface includes a film deposited on the substrate.

3. The method of claim 1, wherein the step of directing thermal radiation from a substrate to a pixel array sensor comprises directing thermal radiation from different positions of the substrate to different segments of the pixel array sensor respectively.

4. The method of claim 3, further comprising the step of measuring temperature and correlating the temperature to the substrate at different positions.

5. The method of claim 2, further comprising the step of directing thermal radiation from a source to the film deposited on the substrate.

6. The method of claim 2, further comprising the steps of:
obtaining spectra of emission and reflection energy from the film; and
extracting deposited film thickness information based on the spectra of emission and reflection energy.

7. The method of claim 1, wherein the pixel array sensor comprises an infrared detector having a wavelength measurement range about 500 to about 1000 nm.

8. The method of claim 1, wherein the pixel array sensor comprises an infrared detector having a wavelength measurement range about 1000 nm to about 100 micron.

9. The method of claim 1, wherein the pixel array sensor comprises an infrared detector, a photoconductive detector, a photovoltaic detector or a photodiode detector.

10. The method of claim 1, further comprising storing measurement data for analysis.

11. The method of claim 1, further comprising processing measurement data in real time.

12. The method of claim 1, wherein the thermal radiation is transmitted through optic fiber.

13. The method of claim 4, wherein the method further comprises:
directing thermal radiation from different positions of the substrate through a slit mask to illuminate a row of segments of the pixel array sensor, wherein the position and temperature information can be correlated.

14. The method of claim 13, wherein the method further comprises:
dispersing light of different wavelengths in the direction perpendicular to the length of the slit by a wavelength dispersive element, wherein one dimension of the pixel array sensor can contain the position information while the other dimension of the pixel array sensor can contain the wavelength information to obtain position sensitive spectrum information.

15. A position sensitive pyrometer comprising:
a pixel array sensor; and
a lens optically connected to the pixel array sensor and proximate to a substrate path, wherein, when a substrate having a surface is in the substrate path, thermal radiation radiates from the substrate through the lens to the pixel array sensor.

16. The position sensitive pyrometer of claim 15, wherein the surface includes a film deposited on the substrate.

17. The position sensitive pyrometer of claim 15, further comprising a plurality of lenses optically connected to the pixel array sensor and proximate to a substrate path, wherein the lenses are directed toward a plurality of positions on the substrate path.

18. The position sensitive pyrometer of claim 16, wherein, when a substrate is in the substrate path, thermal radiation can radiate from a plurality of positions on the substrate through the plurality of lenses to the pixel array sensor.

19. The position sensitive pyrometer of claim 15, wherein the lens is optically connected to the pixel array sensor with an optic fiber cable.

20. The position sensitive pyrometer of claim 16 further comprising:
an active spectral pyrometry device configured to extract deposited film thickness information based on spectra of emission and reflection energy from the film.

21. The position sensitive pyrometer of claim 20, wherein the active spectral pyrometry device comprises a light source generating and directing a light beam onto the film.

22. The position sensitive pyrometer of claim 15, wherein the pixel array sensor comprises an infrared detector, a photoconductive detector, a photovoltaic detector or a photodiode detector.

23. The position sensitive pyrometer of claim 15, wherein the pixel array sensor comprises an infrared detector having a wavelength measurement range about 500 to about 1000 nm.

24. The position sensitive pyrometer of claim 15, wherein the pixel array sensor comprises an infrared detector having a wavelength measurement range about 1000 nm to about 100 micron.

25. The position sensitive pyrometer of claim 15 further comprising a measurement data storage module for analysis.

26. The position sensitive pyrometer of claim 15 further comprising a measurement data processing module for real time diagnosis.

27. The position sensitive pyrometer of claim 15 further comprising a slit mask, wherein the thermal radiation from different positions of the substrate is directed through the slit mask to illuminate a row of segments of the pixel array sensor, wherein the position and temperature information can be correlated.

28. The position sensitive pyrometer of claim 27 further comprising a wavelength dispersive element to disperse light of different wavelengths in the direction perpendicular to the length of the slit, wherein one dimension of the pixel array sensor can contain the position information while the other dimension of the pixel array sensor can contain the wavelength information to obtain position sensitive spectrum information.

29. The position sensitive pyrometer of claim 15 further comprising a spectral imaging module with spectropyrometry.

30. A position sensitive real time deposition monitor with an in-situ configuration for in line deposition process comprising:
a pixel array sensor comprising an infrared detector;
a lens optically connected to the pixel array sensor and proximate to a substrate path, wherein, when a substrate having a surface is in the substrate path, thermal radiation radiates from a film deposited on the surface through the lens to the pixel array sensor;
an active spectral pyrometry device to extract a deposited film thickness information by measuring and analyzing the self-emission of a surface of the deposited film on the substrate; and
a measurement data processing module for real time diagnosis.

31. The position sensitive real time deposition monitor of claim 30, further comprising a plurality of lenses optically connected to the pixel array sensor and proximate to a substrate path, wherein the lenses are directed toward a plurality of positions on the substrate path.

32. The position sensitive real time deposition monitor of claim 31, wherein, when a substrate is in the substrate path, thermal radiation can radiate from a plurality of positions on the film through the plurality of lenses to the pixel array sensor.

33. The position sensitive real time deposition monitor of claim 30, wherein the lens can be optically connected to the pixel array sensor with an optic fiber cable.

34. The position sensitive real time deposition monitor of claim 30, wherein the pixel array sensor comprises an infrared detector, a photoconductive detector, a photovoltaic detector or a photodiode detector.

35. The position sensitive real time deposition monitor of claim 30 further comprising a measurement data storage module for later analysis.

36. The position sensitive real time deposition monitor of claim 30 further comprising a slit mask, wherein the thermal radiation from different positions of the substrate is directed through the slit mask to illuminate a row of segments of the pixel array sensor, wherein the position and temperature information can be correlated.

37. The position sensitive real time deposition monitor of claim 30 further comprising a wavelength dispersive element to disperse light of different wavelengths in the direction perpendicular to the length of the slit, wherein one dimension of the pixel array sensor can contain the position information while the other dimension of the pixel array sensor can contain the wavelength information to obtain position sensitive spectrum information.

38. The position sensitive real time deposition monitor of claim 30 further comprising a spectral imaging module with spectropyrometry.

39. The position sensitive real time deposition monitor of claim 30 further comprising a substrate counting module, wherein the counting module can use the signal change caused by the moving substrates to count the number.

40. The position sensitive real time deposition monitor of claim 39, wherein, with a preset substrate dimension, the counting module can use the signal change caused by the moving substrates to measure the gaps between the substrates and the substrate moving speed.

41. A method of monitoring a substrate comprising:
directing light from a light source to a substrate, wherein the light source comprises a near infrared light source,
directing reflection from the substrate to a pixel array sensor, wherein the substrate has a surface; and
measuring temperature of the substrate from the reflection by the pixel array sensor.

42. The method of claim 41, wherein the surface includes a film deposited on the substrate.

43. The method of claim 41, wherein the step of directing reflection from a substrate to a pixel array sensor comprises directing reflection from different positions of the substrate to different segments of the pixel array sensor respectively.

44. The method of claim 43, further comprising the step of measuring temperature and correlating the temperature to the substrate at different positions.

45. The method of claim 42, further comprising the steps of:
obtaining spectra of emission and reflection energy from the film; and
extracting deposited film thickness information based on the spectra of emission and reflection energy.

46. The method of claim 41, wherein the pixel array sensor comprises an infrared detector.

47. The method of claim 41, wherein the pixel array sensor comprises an infrared detector having a wavelength measurement range about 500 to about 1000 nm.

48. The method of claim 41, wherein the pixel array sensor comprises an infrared detector having a wavelength measurement range about 1000 nm to about 100 micron.

49. The method of claim 41, wherein the pixel array sensor comprises an infrared detector, a photoconductive detector, a photovoltaic detector or a photodiode detector.

50. The method of claim 41, further comprising storing measurement data for analysis.

51. The method of claim 41, further comprising processing measurement data in real time.

52. The method of claim 41, wherein the light from the light source and the reflection from the substrate are transmitted through optic fiber.

53. The method of claim 44, wherein the method further comprises:
directing reflection from different positions of the substrate through a slit mask to illuminate a row of segments of the pixel array sensor, wherein the position and temperature information can be correlated.

54. The method of claim 53, wherein the method further comprises:
dispersing light of different wavelengths in the direction perpendicular to the length of the slit by a wavelength dispersive element, wherein one dimension of the pixel array sensor can contain the position information while the other dimension of the pixel array sensor can contain the wavelength information to obtain position sensitive spectrum information.
